(19) United States
(12) Patent Application Publication
(10) Pub. No.: US 2020/0316728 A1
(43) Pub. Date: Oct. 8, 2020

(54) AUTOMATED WELDING APPARATUS

(71) Applicant: MDO TECHNOLOGIES INC., Saint-Leonard (CA)

(72) Inventors: Didier DURAND, Saint-Leonard (CA); Gauthier ORBAN, Boucherville (CA)

(21) Appl. No.: 16/836,992

(22) Filed: Apr. 1, 2020

Related U.S. Application Data
(60) Provisional application No. 62/828,066, filed on Apr. 2, 2019.

(51) Int. Cl. B23K 37/04; B23K 37/02; B23K 9/02; B23K 9/167; B23K 9/12; B23K 9/127

(52) U.S. Cl. CPC B23K 37/0461; B23K 37/0408; B23K 37/0282; B23K 37/0247; B23K 9/1278; B23K 9/0216; B23K 9/167; B23K 9/126; B23K 37/0241

(57) ABSTRACT

A welding apparatus comprises support members adapted to support parts to be welded, a slit being defined between planes of the support members to expose the parts to be welded. A linear actuator unit having a carriage linearly displaceable along the slit. A welding unit is mounted to the carriage having a torch located substantially below the planes of the support members, and is adapted to be in proximity to the parts via the slit to transmit current to the parts to weld same.

### TECHNICAL FIELD

The present disclosure pertains to automated welding apparatuses.

### BACKGROUND OF THE ART

The welding process has become increasingly automated over time. Indeed, in some instances, the components to weld to one another have repeatable patterns. However, there remains a need for further improvement in the automation of welding.

### SUMMARY

In accordance with an aspect of the present disclosure, there is provided a welding apparatus comprising support members adapted to support parts to be welded, at least a slit being defined between planes of the support members to expose the parts to be welded; a linear actuator unit having a carriage linearly displaceable along the slit; and a welding unit mounted to the carriage having a torch located substantially below the planes of the support members, and adapted to be in proximity to the parts via the slit to transmit current to the parts to weld same.

In accordance with another aspect of the present disclosure, there is provided a welding apparatus comprising a linear actuator unit having a carriage linearly displaceable along the slit; a welding unit mounted to the carriage having a torch and adapted to be in proximity to parts to weld via the slit to transmit current to the parts to weld same; and an oscillator device is mounted to the carriage with at least one rotational degree of freedom, the oscillator device supporting the torch for inducing an oscillatory movement of the torch through linear displacement of the carriage.

### DESCRIPTION OF THE DRAWINGS

FIG. 1 is a first perspective view of an automated welding apparatus in accordance with the present disclosure;

FIG. 2 is a second perspective view of the automated welding apparatus of FIG. 1;

FIG. 3 is an enlarged perspective view of a welding unit on a linear actuator unit of the automated welding apparatus of FIG. 1;

FIG. 4 is a top view of the welding unit of FIG. 3;

FIG. 5 is a perspective view of the welding unit of FIG. 3, in a calibration configuration;

FIG. 6 is a perspective view of the welding unit of FIG. 3, in a welding configuration;

FIG. 7 is an end schematic view showing an oscillating motion for the welding unit of the present disclosure;

FIG. 8 is a perspective view of an oscillating device for the welding unit of the automated welding apparatus of FIG. 1, in accordance with a first embodiment;

FIG. 9 is a top view of the welding unit of FIG. 8 with the oscillating device;

FIG. 10 is a perspective view of the welding unit of FIG. 8 with the oscillating device;

FIG. 11 is a perspective view of an oscillating device for the welding unit of the automated welding apparatus of FIG. 1, in accordance with a second embodiment;

FIG. 12 is a side view of the welding unit of FIG. 11 with the oscillating device;

FIG. 13 is a sectional view of the welding unit of FIG. 12 with the oscillating device, taken along cross-sectional line XIII-XIII;

FIG. 14 is a perspective view of an oscillating device for the welding unit of the automated welding apparatus of FIG. 1, in accordance with a third embodiment;

FIG. 15 is a side view of the welding unit of FIG. 14 with the oscillating device;

FIG. 16 is a perspective view of a centering mechanism for the oscillating device of the welding unit of the automated welding apparatus of FIG. 14;

FIG. 17 is a side view showing an action of the centering mechanism on the parts to weld; and

FIG. 18 is a block diagram showing a controller unit of the automated welding apparatus of FIG. 1.

### DETAILED DESCRIPTION

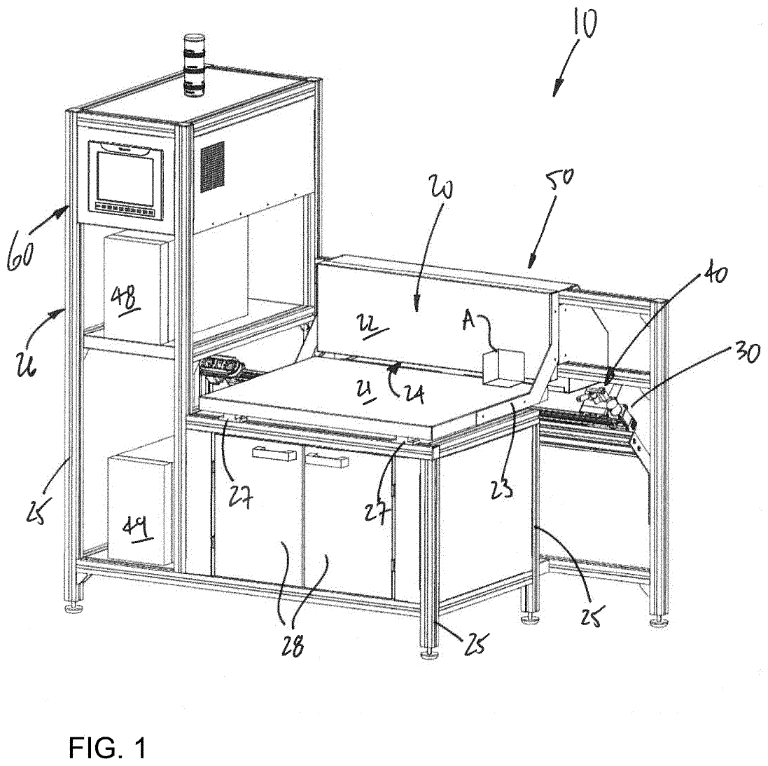

Referring to the drawings and more particularly to FIG. 1, there is illustrated a welding apparatus 10 in accordance with the present disclosure. The welding apparatus 10 is automated, in that the operation of the welding torch is controlled by the apparatus 10, as opposed to being manually handled by a welder, as described in further detail hereinafter. The welding apparatus 10 is configured to perform linear seam welds in joining parts to one another. The welding apparatus 10 is shown as having various components, units and systems, which may include a support table 20, a linear actuator unit 30, a welding unit 40, an environment control system 50 and a controller unit 60.
The support table 20 is the structure of the welding apparatus 10. The support table 20 supports the parts that are to be welded to one another, such as the parts A of FIG. 1, as well as various components, units and systems of the welding apparatus 10.
The linear actuator unit 30 is tasked with displacing the welding unit 40 along a linear path to form the linear seam weld.
The welding unit 40 performs the linear seam weld.
The environment control system 50 isolates the welding unit 40 from ambient, by shielding the welding unit 40 from its environment, and by capturing gases and fumes resulting from the welding process.
The controller unit 60 is the central processor that automates the operation of the various units and systems, to perform a linear seam weld, or linear seam welds of desired parameters, as a function of the parts A to be welded.

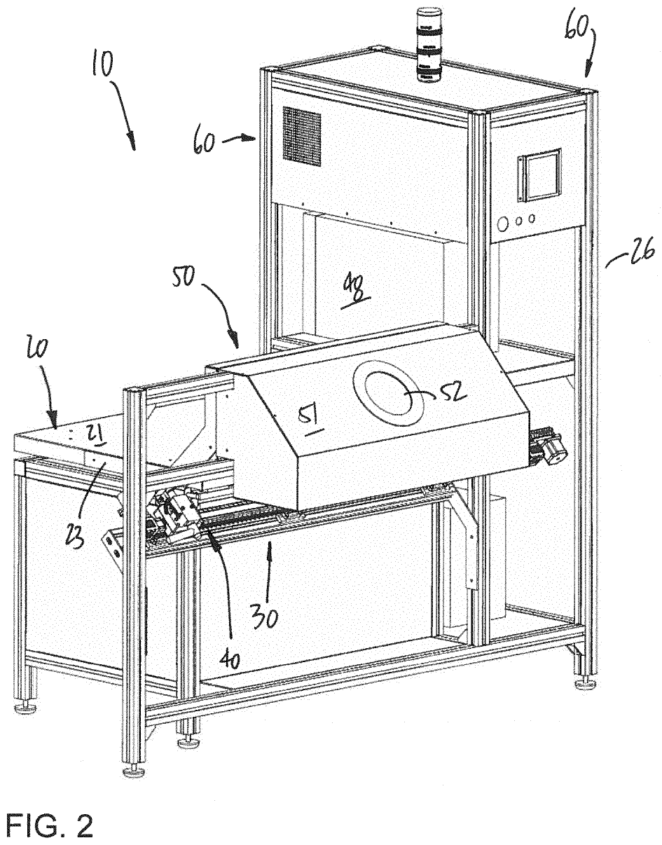

Referring to FIGS. 1 and 2, the support table 20 is shown in greater detail. The support table 20 may have a first support surface 21 a second support surface 22. The support surfaces 21 and 22 may respectively support parts in a designed arrangement. For example, in FIGS. 1 and 2, the support surfaces 21 and 22 are perpendicular to one another, so as to weld parts that will be in a 90 degree relation. Accordingly, a bracket or bracket(s) 23 hold the support surfaces 21 and 22 are a right angle relative to one another, but could also hold the support surfaces 21 and 22 at other angles, such as at 120 degrees, at 135 degrees, etc. The angle between the support surfaces 21 and 22 may be as a function of the shape of the end product to be welded. In an embodiment, the support surfaces 21 and 22 may be displaceable relative to one another, for the support table 20 to be adjustable as a function of a desired angle between the parts to weld. In such a case, the brackets 23 would be mechanisms allowing the movement. Such mechanisms could have indexed positions to set desired orientations between the support surfaces 21 and 22. In yet another embodiment, the brackets 23 may be changed to provide different angles between the surfaces 21 and 22. In the presence of such mechanisms, it is contemplated to motorize them to control their geometrical relation. This may be done by an appropriate actuator and/or motor, and may be controlled by the controller unit 60.

In FIGS. 1 and 2, the first support surface 21 is horizontal, while the second support surface 22 is vertical. The horizontal orientation of the first support surface 21 is convenient for resting the parts A immovably, by the effect of gravity. However, other orientations are contemplated as well. For example, both of the surfaces 21 and 22 may be at 45 degrees from the ground, and at 90 degrees from one another, as one possibility among others. Although not shown, retaining systems may be used to assist in maintaining the parts A in a fixed position on the support table 20 during welding. For example, the support surfaces 21 and/or 22 may include a vacuum system, with suction ports through the support surfaces 21 and/or 22, in fluid communication with a vacuum source. As another possibility, mechanical clamps may be used as well, and may require the assistance of operators in fixing the parts to the support surfaces 21 and/or 22. Distance marks and graduations may be present on the support surfaces 21 and/or 22 to assist in the positioning of parts A on the support surfaces 21 and/or 22, though the distance marks and graduations may not be necessary due to the automated features of the welding apparatus 10.

The support surfaces 21 and 22 are separated from one another by the bracket(s) 23 in such a way that a slit 24 is defined between them. The slit 24 may also be known as an opening, a passage, a channel, a gap. In the illustrated embodiment, the slit 24 extends lengthwise and forms a straight path through which the welding unit 40 may move along the parts A in linear displacement. Accordingly, the width of the slit 24 is great enough for an operating end of a torch on the welding unit 40 to move through it. The space may be greater than a slit 24. In an embodiment, slit entails that there is an elongated opening or gap between support structures (such as the support surfaces 21 and 22) for the welding unit 40 to access elongated seams between parts to weld.

The support table 20 may comprise numerous structural beams, such as 25, to support the support surfaces 21 and 22. For example, the structural beams 25 may define a tower 26 for components of the environment control system 50 and controller unit 60, as described hereinafter. Insulation blocks 27 may raise the support surface 21 from a remainder of the structure, considering that support surfaces 21 and 22 must be conductively part of the welding circuit. Such insulation blocks 27 may also insulate the linear actuator unit 30 from the support table 20 for the same reason. A compartment with doors 28 may also be located under the support surface 21, to store various components, such as components of the environment control system 50 or of a vacuum system for the support surfaces 21 and 22. As another embodiment, other support structures are used instead of the illustrated planar support surfaces 21 and/or 22. Support beams or like elongated members, support posts, and/or clamps, are various support structures or support members that may be used to support a part A that is to be welded in the welding apparatus 10 of the present disclosure.

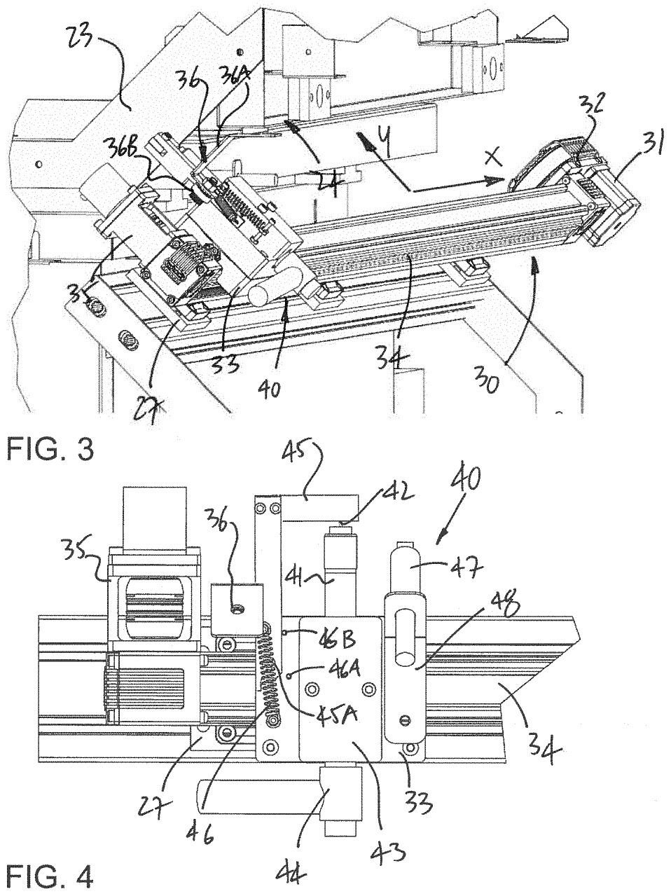

Referring to FIG. 3, the welding unit 40 is shown as operatively mounted to the linear actuator unit 30, for the welding unit 40 to be displaceable reciprocally along direction X, i.e., along the slit 24 between the support surfaces 21 and 22 or equivalent support structure. The linear actuator unit 30 may have of any appropriate type, such as electrical, pneumatic, hydraulic, magnetic, etc. In an embodiment, the linear actuator unit 30 has an electric motor 31. The electric motor 31 may optionally have a reduction gear box 32, so as to control a velocity of a carriage 33 along a rail 34. Although not shown, any appropriate drive may be used to displace the carriage 33 along the rail 34 in direction X, such as a belt drive, a gear drive (e.g., endless screw and ballscrew bearing, etc). The welding unit 40 is mounted to the carriage 33. A sensor 35 such as an encoder may determine the precise location of the carriage 33 along the rail 34. In the illustrated embodiment, the encoder 35 may be mounted to the rail 34 and may be selected as a function of the type of drive of the linear actuator unit 30 (e.g., rotary encoder, optical sensor, ranging device, etc). It is contemplated to mount any appropriate sensor on the carriage A as well, whether additionally or alternatively to the sensor 35, to determine the location of the welding unit 40 along axis X. A direction of displacement of the welding unit 40 is generally parallel to the slit 24, and the structure supporting the linear actuator unit 30 allows the fine tuning of the position for an operator to determine the position of the welding unit 40 relative to the slit 24. The components described above may or may not be present depending on the type of linear actuator used. The linear actuator unit 30 may also have a pusher stop 36. According to an embodiment, the pusher stop 36 may be in the form of a bracket 36A rotatably supporting an idler bearing 36B that is devised to come into contact with a component of the welding unit 40. The pusher stop 36 is mounted to the support table 20 or to any fixed part of the linear actuator unit 30 so as to be immovable. The pusher stop 36 may not be present.

Referring to FIGS. 4-6, an embodiment of the welding unit 40 is shown in greater detail. The welding unit 40 is mounted to the carriage 33 so as to be displaceable along direction X. The welding unit 40 may therefore have a base or platform to support its various components, which base or platform is mounted to the carriage 33 of the linear actuator unit 30. The components may also be mounted directly onto the carriage 33. The welding unit 40 has a torch 41, such as a tungsten inert gas (TIG) torch, having a tip 42. According to an embodiment, the TIG welding causes an autogenous weld, thus without a filler material. The torch 41 supplies the inert gas during the welding process. A nozzle connected to a supply tube may be one of the possible components to supply the inert gas, and may be placed in proximity to the the tip 42. However, the automated welding machine 10 may also perform other types of welding. In some instance, for example when aluminum parts are TIG welded, a filler is required. A filler dispenser may therefore be mounted onto carriage 33, and controlled to provide the appropriate flow of filler.

In the TIG torch embodiment, the tip 42 is a tip of a tungsten rod, for example. A holder 43 releasably holds the torch 41 such that the position of the torch 41 in the Y direction may be adjusted. Indeed, the tip 42 must be at a given distance from the parts A to weld, for the welding to be optimal. Therefore, a fixation screw 44 with handle may be at an end of the torch 41, and is used to fix the torch 41 in the holder 43. The arrangement of the holder 43 and fixation screw 44 is arranged to block movement of the torch 41 along direction Y. While the combination of holder 43 and fixation screw 44 is shown for illustrative purposes, other mechanisms may be used including any appropriate clamps, to lock the torch 41 in the desired position.

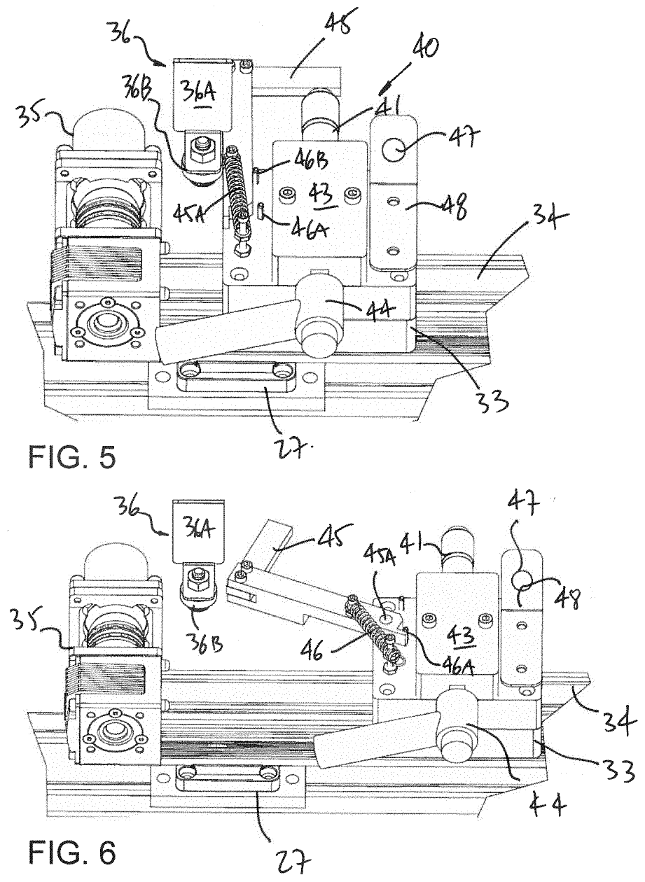

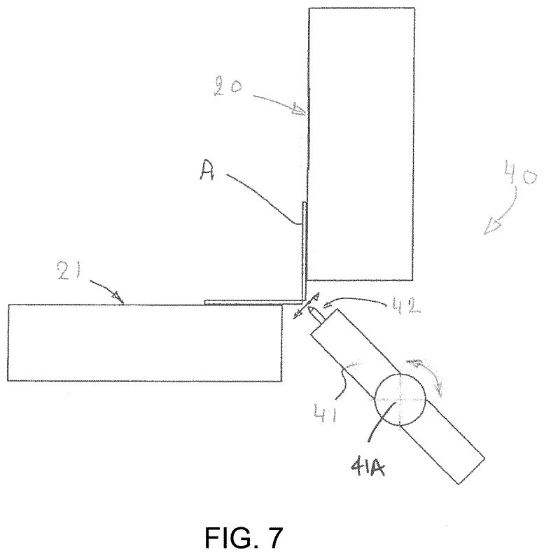

Accordingly, the position of the torch 41 along direction Y may be selected using a calibration arm 45, for the torch 41 to then be locked and prevented from moving, using the fixation screw 44. The calibration arm 45 is optionally used as a mechanical gauge serving as an abutment for the torch 41 in the welding unit 40. The calibration arm 45 may be displaceable between a calibration position in a calibration configuration of the welding unit 40 (FIGS. 4 and 5) and a retracted position in a welding configuration of the welding unit 40 (FIG. 6). In the illustrated embodiment, the calibration arm 45 is pivotally mounted at pivot 45A to the carriage 33 or other base of the welding unit 40. A biasing device 46, such as a torsion spring, leaf spring, etc, biases the calibration arm 45 toward the retracted position of FIG. 6. The calibration arm 45 is limited from rotating by stopper pin 46A coming into abutment with a tail of the calibration arm 45. The pusher stop 36 is positioned in the translational path of the welding unit 40 in such a way that it comes into contact with the calibration arm 45 when the welding unit 40 moves from right to left in the figures, e.g., from the welding configuration of FIG. 6, to the calibration configuration of FIGS. 4 and 5. The calibration arm 45 may thus contact the bearing 36B, which limits friction as the calibration moves along the bearing 36B to reach the calibration position of FIGS. 4 and 5. The calibration arm 45 is in its calibration position of FIGS. 4 and 5 when it abuts the stopper pin 46B. The calibration position of FIGS. 4 and 5 is precisely selected as a function of the positioning of the parts A to weld on the support table 20. In the illustrated embodiment, the calibration arm 45 may have an L shape, though other shapes are possible. With the L shape, the straight segment away from the pivot 45A defines the abutment limit of the torch 41. The tip 42 is therefore brought into contact with the calibration arm 45 as in FIGS. 4 and 5, and is then locked in position by the holder 43 and fixation screw 44. Then, as the welding unit 40 moves toward the right in FIGS. 3-6, the calibration arm 45 moves to its retracted position of FIG. 6, as the calibration arm 45 is released from its contact with the pusher stop 36, the pusher stop 36 causing a swing of the calibration arm 45. The stopper pin 46A is positioned to have the calibration arm 45 retracted enough so as not to come into contact with the parts A.

A user may alternatively use measuring devices (e.g., ruler) or visual markers to properly position the torch 41 in the holder 43, as an alternative to the calibration arm 45. Moreover, the calibration arm 45 may translate relative to the carriage 33 instead of pivoting. The calibration arm 45 may be operational with the biasing of gravity, instead of the biasing from a spring. The calibration arm 45 may have shapes other than a L shape, including T shape, straight shape, etc. In an embodiment, the abutment surface of the calibration arm 45 in the calibration position is oriented such that a direction of translation of the torch 41 is normal to the abutment surface. Moreover, the liner actuator unit 30 could also automate the displacement along the Y direction and/or the displacement of the calibration arm 45, to automate the calibration process.

The welding unit 40 may further include a sensor 47, supported onto the carriage 33 or base of the welding unit 40 by way of a support bracket 48. The sensor 47 may be any appropriate sensor to determine where the parts A are. For example, the sensor 47 may be an optical sensor (e.g., a laser sensor), contact switches, proximity switches and/or magnetic sensors, etc. Although a single sensor is shown, the welding unit 40 may have more than one sensor. The sensor 47 may be placed ahead of the torch 41, to determine when the torch 41 should start and stop its operation. As shown in FIGS. 4 to 6, the torch 41 and the sensor 47 may be at angles from one another to facilitate detection of the edge. For example, if the parts A to weld are to form a reservoir with an outer flange, the reservoir is placed at the left on the support surface 21 with the flange over-hanging. With the sensor 47 ahead of the torch tip 42, a given distance is not welded to avoid collision. To resolve this issue, the sensor 47 may be placed under the torch 41 and inclined looking ahead (e.g., 15 degrees±5 degrees). The torch 41 is also turned sufficiently to clear the flange. In so doing, a very minimal part of the edge is not welded. The sensor 47 may therefore be of the type emitting a light (e.g., infrared, laser) to operate. A light detector may consequently be used to confirm the sensor 47 properly emits light. A position and/or orientation adjustment mechanism may be present to allow a position and/or orientation adjustment of the sensor 47, for example if the type of the parts A to be welded changes.

The welding unit 40 also includes all other necessary components to perform the welding. A welding machine 48 (FIG. 1) may supply the appropriate current for the welding operation, and a torch cooler system 49 may also be present. Although not shown for clarity, wires and conduits extend from the welding machine 48 and the torch cooler system 49 to the welding unit 40. Moreover, the parts A must be grounded, whereby electrodes are also present to conductively contact the parts A. All other usual control sensors may be present, such as current meters, thermocouples, thermometers. Safety components may also be present. Although not shown, the carriage unit 33 can also support an electrochemical TIG weld cleaning system and/or a polishing device as part of the welding unit 40, to clean and/or polish the seam weld.

There may be required the temporary clamping or manual handling of the parts A for tack welding, done for example manually by the operator. The positioning of the welding unit 40 allows welding from under the parts A, by communication through the slit 24. Stated differently, the carriage 33 and a substantial portion of the welding unit 40 on the carriage 33 (if not all) are located below the plane of the support surface 21, and below a bottom end of the support surface 22. Stated differently, the torch 41 is oriented from rear to tip 42 such that an elongated axis thereof has an upward vectorial component. At least 80% of the torch 41 is below the plane of the support surface 21. Among other advantages is the fact that a volume of the apparatus 10 is reduced in comparison to apparatuses welding from above. Moreover, the slit 24 may serve as a baseline or reference axis for the welding apparatus 10. Stated differently, the support surfaces 21 and 22 (or planes of support of the support member) are arranged for the edges to be welded to be located in the slit 24, regardless of the size of the parts A. Accordingly, the welding unit 40 is systematically positioned for welding with limited or no adjustments necessary. If adjustments are to be made, such adjustments are simple, such as displacement of the linear actuator in translation, or displacement of the torch 41.

As best seen in FIG. 2, the environment control system 50 may include a casing 51 that encloses the welding unit 40. The casing 51 may include a ventilation port 52 by which the casing 51 may be connected to a ventilation system to capture fumes and gases emanating from the welding process.

Other components may also be present. For example, a positioner block on a pneumatic actuator may come into contact with the parts in the slit 24. The block may have a shape conforming with the parts (e.g., a right angle) to ensure the parts A are properly positioned relative to one another.

The automated welding apparatus 10 is well suited to weld large components, such as reservoirs. The shape of the reservoirs dictates the arrangement of the surfaces 21 and 22. For example, the perpendicular relation between the support surfaces 21 and 22 may not be adequate for a hexagonal reservoir.

Referring to FIG. 7, there is illustrated another embodiment, in which an oscillating movement may be performed on the torch 41. As schematically shown, the tip 42 may move in a reciprocating movement as a response to the oscillating movement of the torch 41 to essentially both edges of the part A to be welded. The torch 41 may thus oscillate about a pivot axis shown as 41A. In an embodiment a rotational axis of the torch 41 is parallel to the X direction, though other arrangements are contemplated. The frequency and/or amplitude of the oscillations is(are) controlled by a controller unit as described hereinafter. The frequency and/or amplitude may vary as a function of the material to be welded, a material thickness, and/or linear table travel velocity, among possible factors. For example, the amplitude may be driven by the material thickness, while the frequency may define the fineness of the weld pattern and is tied to the travel speed of the linear table for optimum results. The oscillators' function is to maintain a “puddle” of molten metal, riding it over the edges of the two parts to be welded, to enhance repeatability. Full corner and flush corners can be welded without the need for accurate preparatory welds (e.g., tacking of the edges before performing the seam weld). With an oscillation, the weld penetration may be improved and/or thicker materials may be welded with only one pass. The oscillating pattern can be any appropriate one, such as sine, square, triangular, saw tooth.

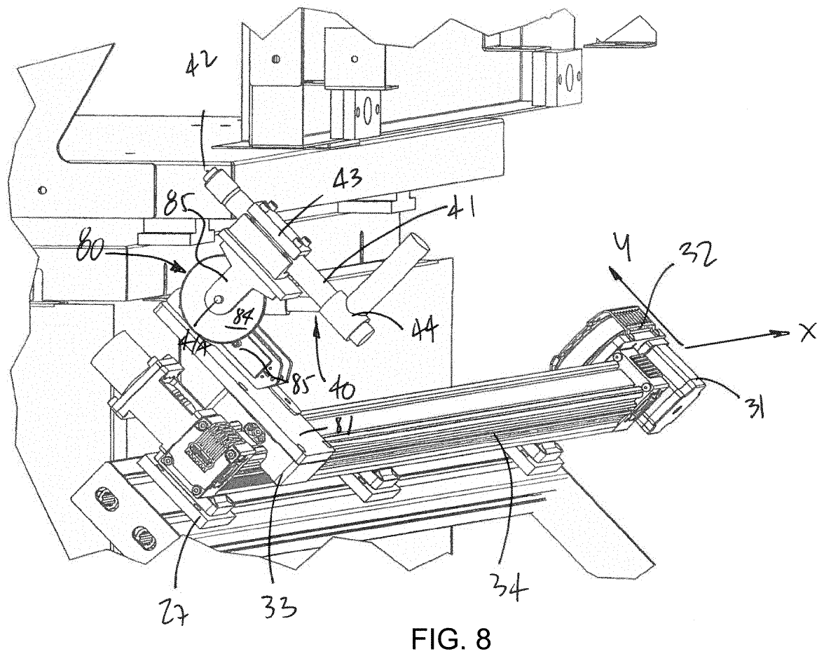

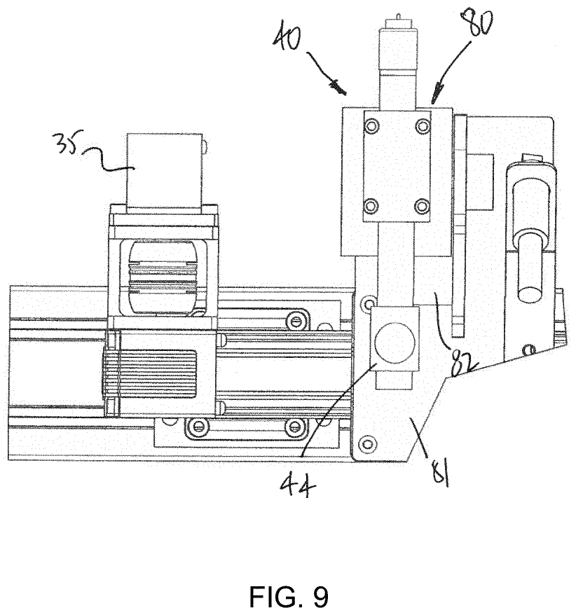

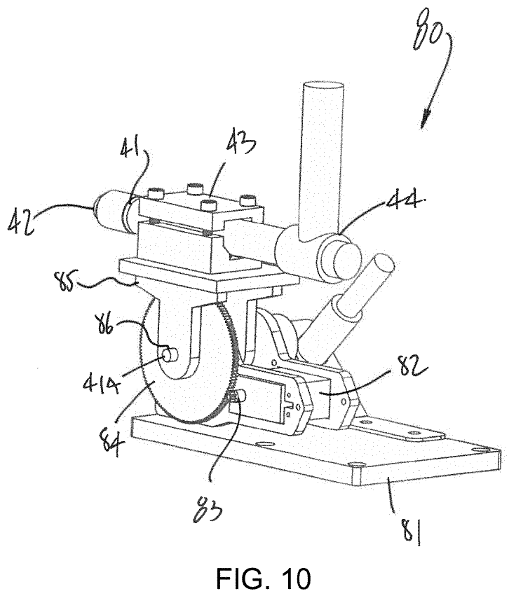

Referring to FIGS. 8-10, an embodiment of an oscillator device is generally shown as 80. The oscillator device 80 is used in combination with some of the components described above, whereby like comments will bear like reference numerals. For example, the oscillator device 80 may be the interface between the carriage 33 and the welding unit 40. In an embodiment, the oscillator device 80 is part of the linear actuator unit 30. The oscillator device 80 may have a base 81 mounted to or part of the carriage 33. The base 81 may have a structure supporting a motor 82, or like actuation means. In an embodiment, the motor 82 is a bidirectional servo motor. A shaft 83 of the motor 82 may be coupled to a wheel 84 connected to a bracket 85. The bracket 85 may be pivotally connected to the base 81 by way of pivot 86. The pivot 86 may define the afore-mentioned pivot axis 41A. Accordingly, rotations of the shaft 83 cause the oscillations of the bracket 85, and thus of the torch 41 mounted to the bracket 85. In an embodiment, the shaft 83 and wheel 84 are gears. The sizes of the shaft 83 and wheel 84 may be selected to cause some gear reduction. Other transmissions are also considered, such as pulleys and cables or tendons, sprockets and chains, serial links, etc. Biasing devices may also be used, such as springs, with unidirectional motors, to cause the oscillations.

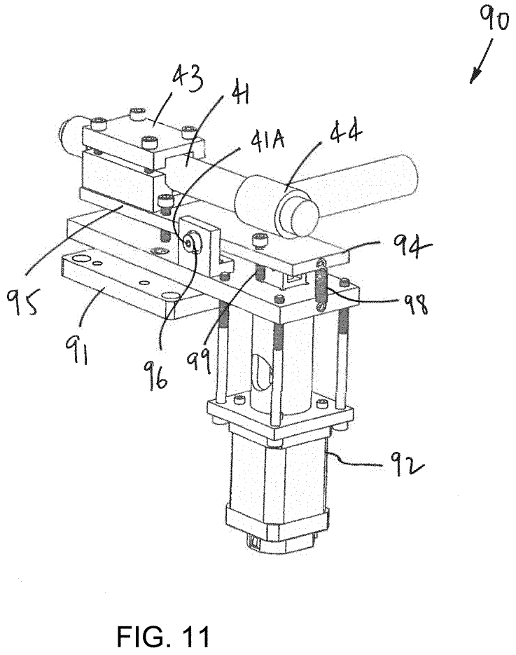

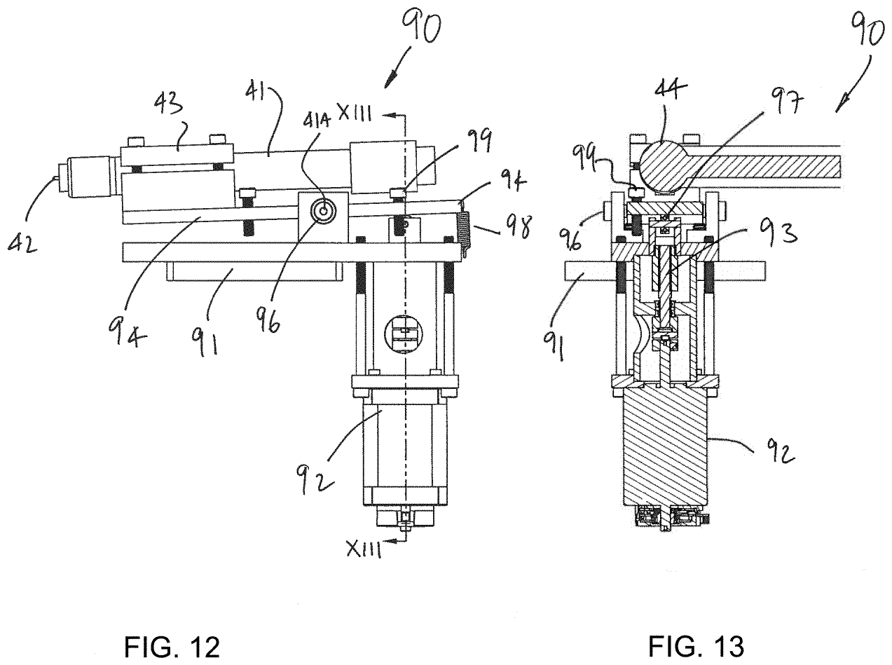

Referring to FIGS. 11-13, another embodiment of an oscillator device is generally shown as 90. Again, the oscillator device 90 may be used in combination with some of the components described above, whereby like comments will bear like reference numerals. For example, the oscillator device 90 may also be the interface between the carriage 33 and the welding unit 40 and may in an embodiment be part of the linear actuator unit 30. The oscillator device 90 may have a base 91 mounted to or part of the carriage 33. The base 91 may have a structure supporting an actuator 92, or like actuation means. In an embodiment, the actuator 92 is a voice call actuator (VCA) or a linear actuator including ball screw. A VCA may provide fine resolution in amplitude, and suitable acceleration for frequency. A shaft 93 of the motor 92 may contact an arm 94 connected to or part of a bracket 95. In fact, while the figures show the arm 94 projecting from a remainder of the bracket 95, the shaft 93 may contact the bracket 95 directly, i.e., no projection. The bracket 95 may be pivotally connected to the base 91 by way of pivot 96. The pivot 96 may define the afore-mentioned pivot axis 41A. Accordingly, a translation of the shaft 93 cause the oscillations of the bracket 95, and thus of the torch 41 mounted to the bracket 95. In an embodiment, a bearing 97 may be placed on the shaft 93 of the actuator 92 for low-friction rolling at a location of contact with the arm 94. Biasing means 98, such as springs, or gravity (not shown) may be positioned between the bracket 95 and the base 91 to ensure contact between shaft 93 and arm 94 or other part of the bracket 95. To control frequency and amplitude, a PWM signal may be provided by a controller unit described below. A limit screw 99 may also be present to set a base orientation of the torch 41.

In the devices 80 and 90, if a servo is used, a driver may be in the servo. If a VCA is used, a driving circuit with firmware may be required. The above oscillator devices 80 and 90 pivot the torch in a direction parallel to the X axis. It is contemplated to add a synchronized oscillation aligned with the Y axis, whereby a rotational pattern may be created to advance and come back on the weld.

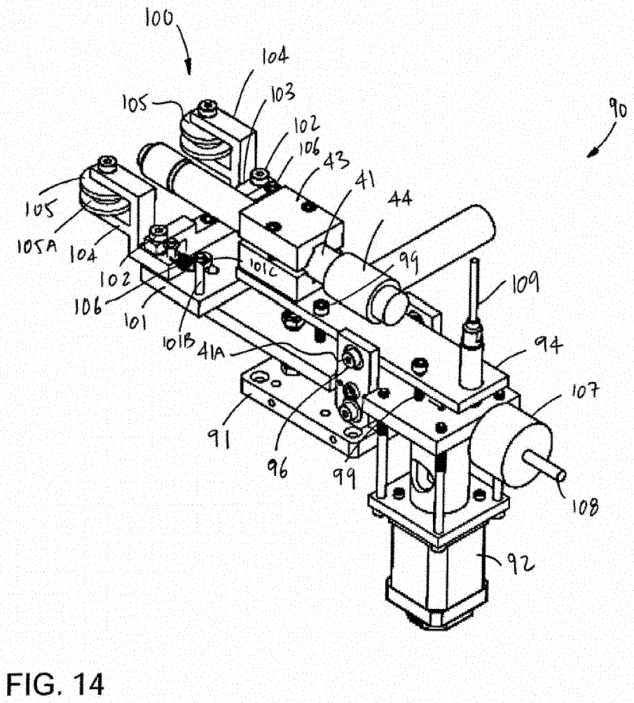

Referring to FIGS. 14-17, a variation of the oscillator device 90 is shown, supporting a centering device 100, that may also be referred to as an alignment device, assembly, mechanism, etc. The centering device 100 may also be present in the other embodiments shown, including the embodiments of FIGS. 8-10, and also embodiments without an oscillator device, such as the embodiment of FIGS. 4 to 6. Depending on the nature of the parts A to weld, some parts may deviate from straight. For example, if two metal sheets are to be welded, the sheets may not be perfectly straight, especially over longer sheets (e.g., over 50 inches). The centering device 100 may therefore assist in keeping the tip 42 of the torch 41 in alignment along the seam of the parts A accessible through the slit 24, whether the tip 42 moves in a linear trajectory, in a sinusoidal trajectory, or any other trajectory.

The centering device 100 is mounted to an end of the oscillator device 90, adjacent to the tip 42. In an embodiment, the centering device 100 has a base 101, for instance in the form of a plate. The base 101 may be in planar sliding engagement with the base 91 of the oscillator device 90. The position of the base 101, may be adjusted for instance by the presence of slots 101A in which fasteners 101C are received, to lock the base 101 in place. Posts 101B may project upwardly from the base 101.

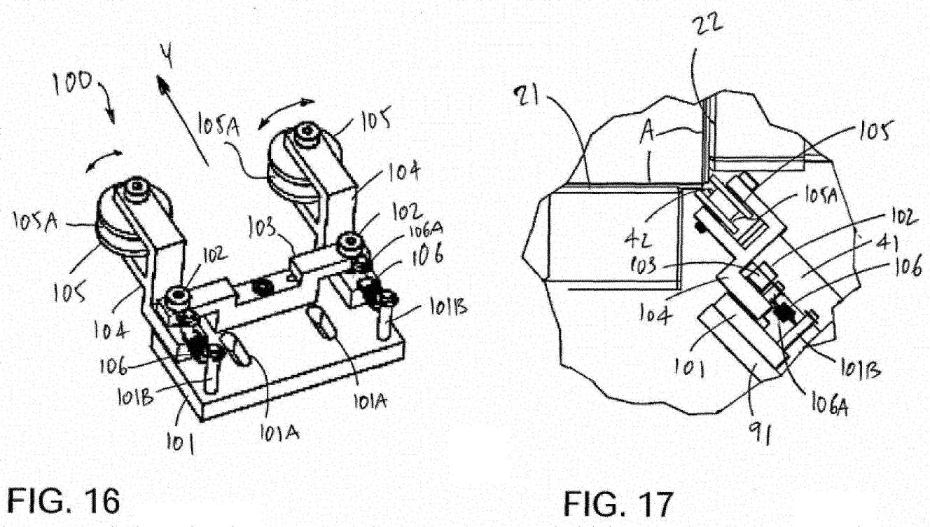

A pair of centering components, such as gimbals, may be present, although a single one may be there as well, or more than a pair. They may each have a pivot 102. A bracket 103 may hold both pivots 102 concurrently, as a possibility. Individual support members may also be used, or the pivot 102 may be self-standing. Arms 104 are pivotally connected to the pivots 102 so as to be pivotable. The orientation of the rotational axes of the pivots 102 may for example be transverse to the direction of translation along axis X. This is shown in FIG. 16, for example. Rollers 105 may be located at the free ends of the arms 104. The rollers 105 may be referred to as idlers. The rollers 105 may be for example pulleys that define a central groove 105A that can catch an edge of the part and remain aligned with it. As an alternative to rollers, low friction pads may be used (e.g., PTFE). Because the rollers 105 have grooves 105A, the corners of the grooves 105A may touch the sides of the parts A to be welded and seek the center, as shown in FIG. 17. However, as the oscillator device 90 is separated from the centering device 100 by one rotational degree of freedom, via pivot 41A, the osciallator device 90 may still oscillate, but based on the trajectory directed by the centering device 100. The base 91 must thus have sufficient play to rotate about the axis X, and such a rotational play may be provided on the carriage 33 as a possibility. As another possibility, the plate of the base 91 upon which the centering device 100 is mounted is pivotally connected to a remainder of the oscillator device 90 at pivot 91B, with a stopper 91A delimiting the amount of play permissible. The stopper 91A may be a bolt with a pair of nuts, as a possibility, so as to enable an adjustment of the amplitude of movement of the centering device 100.

A spring 106 may be connected to posts 101B and 106A. Posts 106A are eccentrically connected to the arms 104 relative to the pivots 102, to bias the arms 104 to be aligned with the Y axis. The springs 106 may force the rollers 105 to find the center and touch on both sides. In an embodiment, two gimbals are present, as shown in FIG. 16; the right one for the beginning of the part A and the left one for the end of the part A. A single gimbal may be present, for example, with other mechanisms to compensate for the end of course. In the case of outward flanged parts A, the right gimbal in FIG. 16 may be pivoted to the left enough to clear the flange, thus allowing the torch 42 to weld closer to the flange end. This can be accomplished in a number of ways, such as, for example an arm strategically placed on the side of surface 21, a solenoid triggered by the controller, etc.

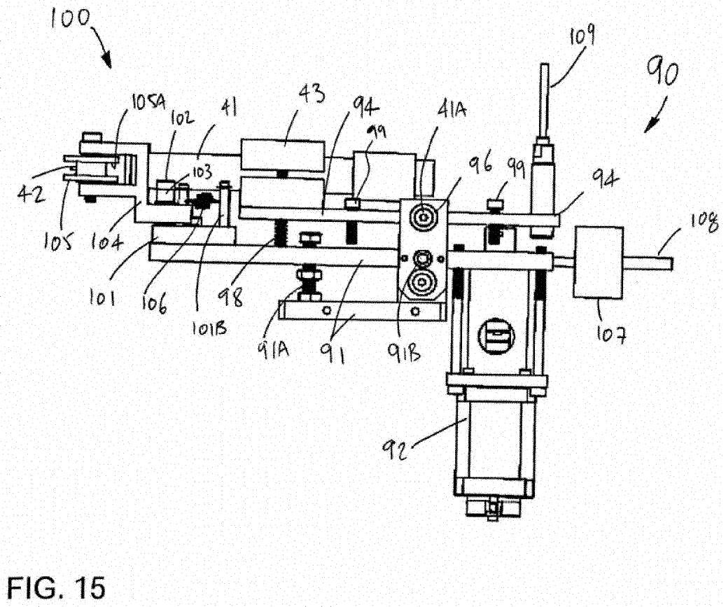

Referring to FIGS. 14 and 15, a counterweight 107 may be added to the base 91, to ensure that the entire oscillator device 90 floats, thus oscillation amplitude of the centering device 100 may be even throughout the length of the part A. A position of the counterweight 107 may be adjusted, for instance by mounting it to a screw 108 by threading engagement. A sensor or trigger 109, such as an optical sensor, may be present to determine or calibrate the orientation of the oscillator 90 before starting a welding operation.

Therefore, in an embodiment, the carriage 33 has one translational DOF relative to the structure of the welding apparatus 10, the translational DOF being actuated by the linear actuator unit 30. The oscillator device 90 may have one DOF (e.g., rotational, but translational possible) relative to the carriage 33, so as to oscillate or move in any appropriate desired way. The DOF (more than one possible) of the oscillator device 90 may be actuated, for instance by the actuator 92. The centering device 100 may have one DOF (e.g., rotational, but translational possible) relative to the carriage 33, independent from the DOF of the oscillator device 90. The gimbal(s) may provide additional degrees of freedom, as explained above.

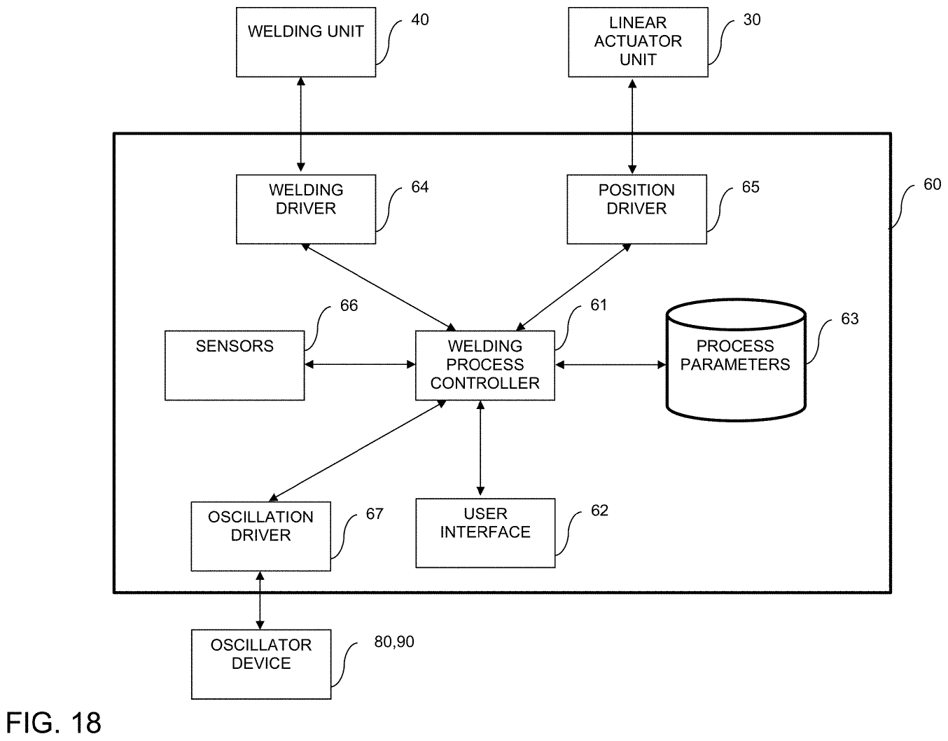

Referring to FIG. 18, a controller unit of the welding apparatus 10 is generally shown at 60. The controller unit 60 is of the type having one or more processors or processing units to control the operation of the welding apparatus 10. In the controller unit 60, a non-transitory computer-readable memory(ies) are communicatively coupled to the processor(s) and comprising computer-readable program instructions executable by the processor(s) to control the apparatus 10. The computer-readable program instructions may include various modules and drivers, such as welding process controller module 61. The welding process controller module 61 is tasked with determining the process parameters of the linear actuator unit 30 and of the welding unit 40 as a function of the specifications of the parts A, such as material (e.g., stainless steel, cold rolled steel, nickel, copper, aluminum, etc, to name a few), the edge type between the parts A, the end type (e.g., presence or absence of a flange), the thickness of the parts A, the geometries of the parts, etc. According to an embodiment, this information is obtained from an operator, via a user interface 62. The user interface 62 may be a touchscreen, a monitor with keyboard, a portable device, with or without wireless communication, etc. According to an embodiment, the welding process controller module 61 runs a process flow to gather the information, for instance with options given for touchscreen selection, and the steps to be performed to initiate welding. The welding process controller module 61 may cause a concurrent and complementary action of the linear actuator unit 30 and of the welding unit 40, for instance when the welding unit 40 has a filler device for producing a flow of filler (e.g., in the case of TIG weld with aluminum). The welding unit 40 produces a flow as a function of the velocity of the carriage of the linear actuator unit 30. In such a case, the operator may be instructed to load the appropriate filler of required diameter with step-by-step instructions by the controller unit 60.

The welding process controller module 61 may have access to a database 63, a process parameter database, to determine welding process parameters as a function of the particulars of the parts to be welded. The process parameters are directly dependent on the particulars of the parts, whereby the programming of the welding process controller module 61 and of the database 63 may be revised over time. Once the process parameters have been determined by the welding process controller module 61, as a function of the particulars of the parts A, the welding process controller module 61 provides the parameters to the welding driver 64 and to the position driver 65, respectively in charge of operating the welding unit 40 and the linear actuator unit 30. Throughout the automated welding process, the sensors of the linear actuator unit 30 and of the welding unit 40 continuously update the respective drivers 65 and 64 to ensure that the welding is in conformity with the process parameters. Sensors 66 may be additionally present to assist the process. For example, the sensors 66 may be used to determine some of the parameters as an alternative to requesting the data from the users. The sensors 66 may also be used by the welding process controller module 61 to confirm or infirm the process parameters entered by the operator. According to an embodiment, the presence of sensors in the apparatus 10 may simplify greatly the information that an operator needs to enter. For example, based on the configuration provided above, the operator may only need to enter three parameters on the user interface 62: material, material thickness, and multiple parts (Yes/No). The controller unit 60 drives the welding machine 48 based on these parameters and controls the welding process accordingly. Multiple parts (Y/N) mean that as many parts as can fit the support table 20 can be placed as long as they are of the same material type and thickness. The controller unit 60 then scans the entire length and welds when it finds parts.

If an oscillator device is present, such as those exemplified at 80 and 90, and oscillator driver 67 may be present. The oscillator driver 67 may control the amplitude and/or frequency of oscillation as detailed above.

Other modules may be present as well, or the welding process controller module 61 may operate other units of the apparatus 10. For example, the welding process controller module 61 may be connected to the vacuum table and start the vacuuming at the appropriate time. The welding process controller module 61 may also operate the environment control system 50, safety modules, beacon, etc.

It is possible to weld horizontally and vertically at the same time with appropriate additional hardware to the welding apparatus 10. For example, two welding machines 48 of two welding units 40 on respective linear actuator units 30. This would half the time to weld a part if more than one seam weld is required. It is also contemplated to weld cylindrical reservoirs, for example, with the welding apparatus 10, with the support table 20 having its surfaces configured for supporting the cylindrical reservoir. An end mechanism could also be provided such that, after welding the linear seam, the end mechanism rotates the cylindrical reservoir using rollers to weld an end cap.

1. A welding apparatus comprising
support members adapted to support parts to be welded, at least a slit being defined between planes of the support members to expose the parts to be welded;
a linear actuator unit having a carriage linearly displaceable along the slit; and
a welding unit mounted to the carriage having a torch located substantially below the planes of the support members, and adapted to be in proximity to the parts via the slit to transmit current to the parts to weld same.

2. The welding apparatus according to claim 1, wherein the welding apparatus has a TIG torch.

3. The welding apparatus according to claim 1, further comprising a calibration arm to assist in determining a position of a tip of a torch of the welding unit.

4. The welding apparatus according to claim 1, wherein the carriage has a holder for releasably locking the torch in translation.

5. The welding apparatus according to claim 1, wherein an oscillator device is mounted to the carriage with at least one rotational degree of freedom, the oscillator device supporting the torch for inducing an oscillatory movement of the torch through linear displacement of the carriage.

6. The welding apparatus according to claim 5, wherein an axis of the rotational degree of freedom of the oscillator device is substantially parallel to a direction of the linear displacement of the carriage.

7. The welding apparatus according to claim 5, wherein a linear actuator is part of the oscillator device to cause the oscillating movement about the rotational degree of freedom.

8. The welding apparatus according to claim 7, wherein the linear actuator is transverse to the direction of linear displacement of the carriage.

9. The welding apparatus according to claim 7, wherein a biasing unit is provided against the rotational degree of freedom to assist the linear actuator.

10. The welding apparatus according to claim 5, wherein a centering mechanism is mounted to the carriage with another rotational degree of freedom, the centering mechanism adapted to be guided along an edge of the parts to follow a trajectory of the edge.

11. The welding apparatus according to claim 10, wherein the centering mechanism has a pair of rotatable arms.

12. The welding apparatus according to claim 11, wherein rollers are mounted at the end of the arms and are configured to roll along the edge of the parts.

13. The welding apparatus according to claim 12, wherein the rollers are pulleys.

14. The welding apparatus according to claim 11, wherein springs bias the arms to a contact with the edge.

15. The welding apparatus according to claim 10, wherein at least one counter-weight assists in keeping the centering mechanism is the trajectory.

16. The welding apparatus according to claim 1, wherein a centering mechanism is mounted to the carriage with another rotational degree of freedom, the centering mechanism adapted to be guided along an edge of the parts to follow a trajectory of the edge.

17. A welding apparatus comprising
a linear actuator unit having a carriage linearly displaceable along the slit;
a welding unit mounted to the carriage having a torch and adapted to be in proximity to parts to weld via the slit to transmit current to the parts to weld same; and
an oscillator device is mounted to the carriage with at least one rotational degree of freedom, the oscillator device supporting the torch for inducing an oscillatory movement of the torch through linear displacement of the carriage.

18. The welding apparatus according to claim 17, wherein an axis of the rotational degree of freedom of the oscillator device is substantially parallel to a direction of the linear displacement of the carriage.

19. The welding apparatus according to claim 18, wherein a centering mechanism is mounted to the carriage with another rotational degree of freedom, the centering mechanism adapted to be guided along an edge of the parts to follow a trajectory of the edge.

20. The welding apparatus according to claim 19, wherein the centering mechanism has a pair of rotatable arms, rollers being mounted at the end of the arms and are configured to roll along the edge of the parts.
